(19) United States
(12) Patent Application Publication
(10) Pub. No.: US 2018/0362118 A1
(43) Pub. Date: Dec. 20, 2018

(54) GRID STRUCTURES FOR STABLE GAS RETENTION UNDER LIQUIDS

(71) Applicant: RHEINISCHE FRIEDRICH-WILHELMS UNIVERSITÄT BONN, Bonn (DE)

(72) Inventors: Wilhelm Barthlott, Bonn (DE); Birte Böhnlein, Karlsruhe (DE); Matthias Mail, Waghäusel (DE)

(73) Assignee: RHEINISCHE FRIEDRICH-WILHELMS UNIVERSITÄT BONN, Bonn (DE)

(21) Appl. No.: 16/060,351

(22) PCT Filed: Dec. 21, 2016
(86) PCT No.: PCT/EP2016/082194

§ 371 Date: Jun. 7, 2018

(30) Foreign Application Priority Data
Dec. 23, 2015 (DE) 10 2015 122 780.0

(51) Int. Cl. B63B 1/38

(52) U.S. Cl. CPC B63B 1/38; B08B 17/065; B63B 2001/387

(57) ABSTRACT

Device mountable on a surface (10), the device comprising a spacer system (12, 16, 20, 22) and a grid structure (2) which grid structure (2) is attached in spaced relation to the surface (10) by means of the spacer system (12, 16, 20, 22), wherein the distance between the surface (10) and the grid structure (2) is in a range from >0.1 μm to <10 mm, wherein the grid structure (2) forms meshes of a mesh size in a range from >0.5 μm to <8 mm, and wherein the surface of the grid structure (2) is at least partially amphiphobic. Method of maintaining a gas or air layer on a surface when the surface is immersed in a liquid or water comprising such device, and uses thereof.

The present invention relates to the technical field of non-wettable surfaces, and the use thereof.

Structured, non-wettable surfaces are used for different applications, for example as self-cleaning surfaces. Document WO 2007/099141 discloses unwettable surfaces having filaments bound to the surface. Document WO 2009/095459 discloses unwettable surfaces having filaments bound to the surface, wherein the filaments are structurally or chemically anisotropic. Document DE 10 2011 121796 discloses unwettable surfaces having filaments bound to the surface, wherein the filaments have different lengths. Such surfaces fitted with filaments are able to entrap air within the structures when the surface is immersed in water in a way that the air is not displaced by water. Hair-like filaments are derived from natural models such as the floating ferns Salvinia and backswimmers Notonecta, and are able to provide a long-term stabilization of an air layer upon a surface submerged in water. Filamental structures however require a complex and costly manufacture and are difficult to be applied in practice.

Thus, there remains a desire for surfaces that are able to stabilize an air layer upon the surface, particularly which are not wet after being contacted with water.

It is the object of the invention to provide such surfaces.

This object is achieved by a device mountable on a surface, the device comprising a spacer system and a grid structure which grid structure is attached in spaced relation to the surface by means of the spacer system, wherein the distance between the surface and the grid structure is in a range from ≥0.1 μm to ≤10 mm, wherein the grid structure forms meshes of a mesh size in a range from ≥0.5 μm to ≤8 mm, and wherein the surface of the grid structure is at least partially amphiphobic.

It has been surprisingly found that surfaces equipped with grid structures can provide a stable gas layer particularly an air layer on the surface when the surface is immersed in a fluid such as water. A further advantage is that the stability of the grid structure itself against mechanical force is significantly improved compared to surfaces equipped with filaments. Grid structures are much less susceptible to structural defects which would lead to a loss of the gas layer on the surface. Grid structures on the one hand are able to elastically absorb mechanical stress. On the other hand, even in case mechanical impact may destroy some of the spacers which may be placed between the surface and the grid structure to buttress the spacing between grid and surface, the grid structures are able to maintain the gas layer.

The grid structures advantageously are suitable for a use under dynamic conditions such as fast-flowing bodies of water. Grid structures can be easily and reasonably manufactured and thus enable a commercial use. Grid structures can be manufactured for a use on large surface areas such as ship bodies. Large-scale grids or meshes can easily and homogeneously be produced, applied to a substructure and fixed in place.

Surfaces equipped with a grid structure are able to entrap air between the grid and the surface in a way that it is not displaced by water; thus, the surfaces are unwettable. The surfaces equipped with a grid structure especially are suitable for long-term applications or for applications in fast-flowing bodies of water. The grid structures advantageously allow to retain an air layer even in currents. Such non-wettable surfaces particularly are able to reduce the frictional resistance between water and the surface of a ship body. The grid structures further have other properties that are desirable from a technological point of view, such as avoiding of biofouling.

Grids further are an advantageous additional prerequisite for the application of microbubble technologies. The air bubbles attaching e.g. a ship hull may be easily integrated in the air volume enclosed by the grids and thus the function may be maintained or stabilized even under unfavorable hydrodynamic conditions. Further, a regeneration of the air layer is possible over a longer period of time.

The surface of the grid structure is at least partially amphiphobic. That is, the contact angle between the grid structure and a liquid is greater than 90°. The term “amphiphobic” refers to an object that repells liquids, and particularly is hydrophobic as well as oleophobic. In embodiments the surface may be hydrophobic or oleophobic, particularly the surface is hydrophobic. The contact angle between the grid structure and a fluid, particularly water, preferably is greater than 100°. This can be measured, for example, with an inverted microscope and ultrasonic atomization as described in Suter et al., Journal of Arachnology, 32 (2004), pages 11 to 21. Preferably, the contact angle is greater than 110°. The hydrophobicity can also be measured macroscopically. Materials according to the disclosure preferably have macroscopic contact angles of greater than 140°. The material forming the grid structure may be amphiphobic or hydrophobic. The grid structure for example may be formed from a polytetrafluoroethylene, such as the material known by the brand name “Teflon” by DuPont Co. In case hydrophilic materials are used for the grid structure, hydrophobicity may be provided by hydrophobizing the surface of the material, for that the surface of the grid structure which is exposed to a gas and a fluid is amphiphobic or hydrophobic.

A “grid structure” comprises a series of intersecting structure elements which by crossing form a network or a grid. Grid structures not only include networks such as meshes, nets and grids but also perforated plates and gratings. Grid structures include meshes of connected strands of materials such as metal, fiber or other preferably flexible materials, nets in which filaments are attached or fused to form a fabric with meshes between the filaments, webs, or gratings. The structure elements between the meshes depending on the form of networks may be in the form of strips, bars, webs, strands or filaments. Regardless of the form, the basic components of the structures share the common principle of repetition of meshes or apertures, which may have a basic geometric design. The grid structure particularly comprises a multitude of meshes or apertures.

The grid structure may be formed by any structure providing the necessary dimensions to ensure the forming of meshes for holding a gas film on the surface. In preferred embodiments, the grid structure is provided by a perforated plate, a grating, a net, a woven or non-woven mesh, or is formed by woven or non-woven filaments. A mesh particularly may be a metal mesh, a wire mesh, or a metal grating. A metal mesh may be woven, knitted, welded, expanded, photo-chemically etched or electroformed from steel or other metals. The mesh also may be a plastic mesh, which may be extruded, oriented, expanded, woven or tubular. Plastic meshes may be made from polypropylene, polyethylene, nylon, polyvinylchloride, or polytetrafluorethylene. The grid structure may be manufactured from various materials, preferably from metal, steel, plastic, or epoxy resin. Steel provides high tensile strength and the structures can be manufactured with low cost, while plastics provide high elasticity. If the material such as a plastic itself does not provide sufficient hydrophobicity, the material may be hydrophobiced, for example with polytetrafluoroethylene (PTFE) such as PTFE-based formulas known by the brand name “Teflon” by DuPont Co. Preferably the grid structure may be selected from a perforated plate, such as a metal perforated plate or a replication made from epoxy resin, a wire mesh, or a plastic web which may be hydrophobized.

Perforated plates provide a wide range of patterns of meshes or apertures such as round holes, round end slots which may be parallel or staggered, square end slots, or square holes. In embodiments, the meshes or apertures in the grid structure may have a round, square, oblong, polygonal such as hexagonal, or arrow-shaped form. Usually such meshes or apertures have a regular shape and distribution. In preferred embodiments, the grid structure forms meshes of a mesh size in a range from >5 μm to ≤2 mm, more preferably in a range from ≥10 μm to ≤800 μm. The grid structure in other embodiments may be formed by fibers or filaments which may be woven or non-woven or even form knitted nets. Meshes may thus alternatively have irregular forms and distribution. The form and arrangement of the meshes or apertures and also the profile of a web or filaments forming a grid structure may vary depending on the grid material. The diameter of webs in the grid structure or of filaments of the grid structure may be in a range from ≥0.1 μm to ≤2 mm, preferably in a range from ≥25 μm to ≤500 μm. Grids or webs formed from thin filaments having narrow meshes advantageously can provide a stable gas layer on the surface.

The grid structure and/or the filaments forming the grid structure may be formed from elastic or rigid materials. The grid structure may have an elasticity as determined by the modulus of elasticity in a range from ≥10⁴ N/m² to ≤10¹⁴ N/m². Preferably, the flexural modulus of elasticity is also within these ranges. The elasticity allows within limits an elastic movement of the grid structure with an external pressure acting on the grid such as a moving water body. Advantageously, movements of the surrounding water can be absorbed elastically by such grid structures. The grid structure may be formed from combinations of elastic and rigid materials.

In embodiments, the grid structure may be at least partially or entirely amphiphobic, preferably partially or entirely hydrophobic. The amphibobic or hydrophobic characteristic of the grid structure prevents a liquid such as water from entering the grid and thus encloses a gas layer between the grid structure and the surface when the surface is immersed in a liquid. In embodiments, the grid structure however may comprise amphiphilc or hydrophilic regions, so that the contact angle between this region and a liquid or water is <90°. Particularly a region of the surface of the grid structure facing the liquid, i.e. the grid surface opposite to the surface of an object on which the grid structure is provided, may be hydrophilic. Such hydrophilic regions advantageously can stabilize the gas layer on the surface. Hydrophilic regions advantageously may prevent the grid structure from losing contact to a liquid surrounding the grid structure and thus the formation of bubbles stretching over several meshes which are able to detach and rise upwards.

In embodiments, the grid structure may comprise protrusions, particularly on the grid surface opposite to the surface of the object on which the grid structure is provided. In other words, the grid structure may comprise protrusions on the grid surface facing the liquid. The term “protusion” as used herein includes any structures that extend from the grid structure, and particularly may have the form of a stud or nub or a filament. The protrusions may be formed of the grid material. In embodiments, the grid structure may comprise protrusions on the grid surface facing the liquid which are amphiphobic or hydrophobic, or least partially amphiphobic or hydrophobic, as is the grid structure. Preferably, the protrusions may be provided in regular distance from each other. The protrusions thus allow for providing an enlarged gas or air layer on the surface extending to the tips of the protrusions. The tips of the protrusions provide for that the contact area thus is reduced and friction reduction improved. Particularly in case of low pressure on the liquid, the grid structure may be able to entrap a gas layer between the tips of the structures or protrusions and the surface. By using protrusions on the grid structure, in embodiments a height of the gas layer in a range from ≥0.1 μm to ≤15 mm may be provided. In case of increasing pressure, the remaining gas layer can be held by the grid structure, and may be stabilized by a compartimenzation. In other embodiments, the grid structure may comprise amphiphilc or hydrophilic protrusions. Such protrusions preferably may be provided on junctions of the grid structure or filaments forming the grid structure. The protrusions may be coated with a hydrophilic material or may be formed from a hydrophilic material. Such hydrophilic structures may provide for a pinning effect and thus stabilize the gas-liquid-interphase.

The surface on which the grid structure is provided is variable. Preferred surfaces are surfaces of objects that are permanently immersed in liquids or water, for example, bodies of ships and boats, pipelines etc.

The grid structure is affixed in spaced relation to the surface. The distance such formed between the surface and the grid structure defines the height of the gas layer formed between grid structure and surface. A distance between grid structure and the surface and thus a height of the gas layer in a range from ≥0.1 μm to ≤10 mm has proven suitable. In preferred embodiments, the distance between the surface and the grid structure is in a range from ≥1 μm to ≤6 mm, preferably in a range from ≥10 μm to ≤2 mm. A thick gas layer provides for an advantageously good reduction of frictional resistance between a liquid such as water and the surface for example of a ship body. With rising thickness of the gas layer on the other hand decreases the stability due to an increase in the susceptibility to disrupture by mechanical stress. The distance between grid structure and surface and thus the height and the stability of the gas layer can be adapted according to the dynamic conditions. If, for example in case of thick air layers or high velocity, a loss or a partial loss of the air layer may occur, the air layer may be regenerated for example via the microbubble technologies.

In preferred embodiments, the spacer system is formed by spacers placed between the surface and the grid structure. Spacers advantageously support or ensure a uniform distance between the surface and the grid structure. In embodiments, the spacer system is formed by spacers having the form of solitary rodlike bars or wall-like ledges, or the spacer system is formed by a porous layer, or the spacer system is provided as a combination thereof. The spacers may be solitary structures such as single rodlike bars. Such rodlike bars may be cylindrical or conical, or may have a star-like cross-section, or the solitary structures may be ball-shaped. The spacers may be provided in suitable density to mechanically stabilize a grid of given heaviness. In other embodiments, the spacer may be provided by a porous layer. The term “porous” material refers to a material containing voids. Such voids may entrap a gas and thus provide for a gaseous layer between grid and surface. The matrix material preferably is an elastic structure like a foam or a sponge-like structure.

The spacers may also be provided in the form of bars or wall-like ledges. Such wall-like structures may have variable cross-sections. Wall-like bars and ledges may support the grid structure. Wall-like bars and ledges further can divide the space between the grid and the surface into compartments and thus allow for the construction of separate compartments providing separate gas volumes. Wall-like bars and ledges thus may provide a boundary and restrict the gas layer under the grid structure to separate volumes. In preferred embodiments, the wall-like ledges form compartments on the surface. Dividing the gas layer into separate compartments advantageously can support a stable, long-term maintenance of a gas layer even under compressive load or currents. Particularly if one or some compartments may be disrupted by water pressure or currents other separate compartments still can maintain a gas layer.

The area of such compartments may vary. In embodiments, the compartments may have a diameter in a range from ≥10 μm to ≤10 cm, preferably in a range from ≥100 μm to ≤5 cm, more preferably in a range from ≥800 μm to ≤1.5 cm. Such compartments advantageously can provide for stable gas volumes. The extension of the compartments and thus the extension and stability of the gas layer can be adapted according to the dynamic conditions. Generally, smaller gas layers or gas volumes are more stable than gas layers with larger dimension. The form of the compartments may vary. The compartments may have a hexagonal base area or a honeycomb structure or may have an oblong form. Preferred are oblong compartments in a longitudinal direction to the movement of a liquid around the surface.

In embodiments, a combination of wall-like bars or ledges forming compartments and solitary spacers such as rodlike bars are preferred, wherein the rodlike bars preferably are provided inside the compartments. The wall-like bars or ledges form the boundaries of the compartments and support the grid structure above, while the rodlike spacers inside the compartments stabilize the grid and ensure an equal distance of the grid structure over the area of the compartment.

The elements below the grid such as the spacers and/or the surface may be at least partially or entirely amphiphobic, preferably partially or entirely hydrophobic. Particularly the spacers such as solitary rodlike bars as well as wall-like ledges or spacers formed by a porous layer may be hydrophobic. In embodiments, the spacers and/or the surface however also may comprise amphiphilic or hydrophilic regions.

In embodiments, the wall-like ledges forming compartments comprise through-going or continuous openings. Such through openings in the compartment walls allow for an exchange of gas between adjacent compartments. Providing a gas exchange between separate gas volumes supports a pressure compensation. Preferably the through openings are arranged to close under increasing pressure. Connections between the compartments can be provided by rectangular, triangular or circular through openings in the wall-like ledges forming compartments walls. Such connections between separate compartments provide for a gas exchange. In case an exterior pressure, such as static pressure or a current, exceeds a defined limit and presses a liquid in a compartment, the gas in this compartment is compressed and the liquid-gas-interface decreases below the level of the connecting holes and the holes are sealed by the liquid. Thus the gas exchange between adjacent compartments is interrupted. In the case of variable stresses, such as water flows or isolated pressure fluctuations, the gas can be transferred in adjacent compartments and is not entirely removed. After attenuation of the external pressure a pressure compensation can take place between the compartments and a continuous gas layer can be restored.

The through openings preferably are provided near the grid structure in the upper third, preferably just below the grid. The through openings in the wall-like ledges providing connections between adjacent compartments may have a depth as deep as about two-thirds, preferably up to one third of the height of the compartment wall. The through openings can have a width of up to 95%, preferably up to 50%, of the width of the compartment wall. The area of the through openings may amount to about two-thirds, preferably to one third, of the surface of the wall-like ledges providing the compartment wall. Any number of through openings in the compartment walls may be provided.

In embodiments, each compartment can be connected to all adjacent compartments. In other embodiments, only selected compartments or segments comprising a designated number of compartments may be connected by through openings. In embodiments, a selected sector or area of compartments may be connected, such as, for example compartments in direction of the current of a liquid along the surface, while connections of compartments transverse to a current are not provided.

Parameters particularly selected from the group comprising the size of the through openings, the mesh size of the grid structure, thickness of the grid structures or the diameter of filaments forming the grid, the height and the density of the spacers, may vary by a factor up to 100, preferably up to 50. Such variations of the parameters advantageously can compensate for altering pressure under dynamic conditions.

In embodiments, the surface may be covered by a grid structure. In further embodiments, the surface may be partially covered by grid structures. For example, the bottom of ship hulls may be covered by a grid structure to generate a stable air film around the hull to reduce friction. If an object however has a predefined orientation towards a flowing body of a liquid it may be sufficient to equip only these parts of the surface with grid structures which suffer the major stress.

Another aspect refers to an object comprising a device mountable on a surface, the device comprising a spacer system and a grid structure which grid structure is attached in spaced relation to the surface by means of the spacer system, wherein the distance between the surface and the grid structure is in a range from ≥0.1 μm to ≤10 mm, wherein the grid structure forms meshes of a mesh size in a range from ≥0.5 μm to ≤8 mm, and wherein the surface of the grid structure is at least partially amphiphobic, according to the invention. Regarding the design and function of the grid structure, spacers, surface and compartments it is referred to the description given above. Preferred objects are structures that are temporarily and particularly permanently immersed in liquids or water, for example, bodies of ships and boats, pipelines etc.

Another aspect refers to a method of maintaining an air layer on a surface when the surface is immersed in a liquid or water, the method comprising providing a device mountable on a surface, the device comprising a spacer system and a grid structure which grid structure is attached in spaced relation to the surface by means of the spacer system, wherein the distance between the surface and the grid structure is in a range from ≥0.1 μm to ≤10 mm, wherein the grid structure forms meshes of a mesh size in a range from ≥0.5 μm to ≤8 mm, and wherein the surface of the grid structure is at least partially amphiphobic. Regarding the design and function of the grid structure, spacer system, surface and compartments it is referred to the description given above.

The distance between grid structure and surface and thus the height of the gas layer can be adapted, particularly in a range from ≥0.1 μm to ≤10 mm, preferably in a range from ≥1 μm to ≤6 mm, more preferably in a range from ≥10 μm to ≤2 mm. Further, the extension of the compartments and thus the extension of the gas layer can be varied, the compartments for example having a diameter in a range from ≥10 μm to ≤10 cm, preferably in a range from ≥100 μm to ≤5 cm, more preferably in a range from ≥800 μm to ≤1.5 cm. By altering the distance between grid structure and surface and the extension of the compartments, and thus the volume of the gas layer, respectively, the stability of the gas layer can be adapted, for example according to dynamic conditions. The volume of the gas layer also may be adapted or restored in combination with microbubble technologies.

Further, the elasticity of the grid structure and/or the filaments forming the grid structure or the spacer system, respectively, may be varied to compensate for the varying conditions of dynamic drag effects. The elasticity as determined by the modulus of elasticity may be varied in a range from ≥10⁴ N/m² to ≤10¹⁴ N/m².

Further, form and shape of the grid structures as well as the characteristics regarding amphiphobicity or hydrophobicity may be varied to compensate for the varying conditions of dynamic drag effects. Grid structures having meshes or apertures such as round holes, round end slots which may be parallel or staggered, square end slots, square holes, may be used. Meshes or apertures in the grid structure having a round, square, oblong, polygonal such as hexagonal, or arrow-shaped form may be used. Grid structures having meshes or apertures with irregular forms and distribution may be used. Grid structures form meshes of a mesh size in a range from ≥0.5 μm to ≤8 mm, preferably in a range from ≥5 μm to ≤2 mm, more preferably in a range from ≥10 μm to ≤800 μm, may be used. Grid structures formed from fibers or filaments which may be woven or non-woven or even form knitted nets may be used. Grid structures having a diameter of webs in the grid structure or of filaments of the grid structure in a range from ≥0.1 μm to ≤2 mm, preferably in a range from ≥25 μm to ≤500 μm, may be used.

Further, a grid structure may be used which comprises protrusions, particularly on the grid surface opposite to the surface of the object on which the grid structure is provided. The protrusions on the grid surface may be provided on junctions of the grid structure. The structures may be amphiphobic or hydrophobic, or least partially amphiphobic or hydrophobic, as is the grid structure. In other embodiments, the protrusions may be coated with a hydrophilic material or may be formed from a hydrophilic material. By using protrusions on the grid structure, in embodiments a height of the gas layer in a range from ≥0.1 μm to ≤15 mm may be provided.

The grid structures are well-suited for a use under dynamic conditions such as fast-flowing bodies of water. Also under these conditions, the volume of the gas layer may be adapted or restored in combination with microbubble technologies.

Another aspect refers to the use of a device mountable on a surface, the device comprising a spacer system and a grid structure which grid structure is attached in spaced relation to the surface by means of the spacer system wherein the distance between the surface and the grid structure is in a range from ≥0.1 μm to ≤10 mm, wherein the grid structure forms meshes of a mesh size in a range from ≥0.5 μm to ≤8 mm, and wherein the surface of the grid structure is at least partially amphiphobic, according to the invention for maintaining an air layer on the surface when the surface is immersed in a liquid or water.

Interesting applications for surfaces equipped with a grid structure maintaining an air layer are applications in which structures are permanently immersed in liquids or water, for example, bodies of ships and boats, pipelines etc.

A device mountable on a surface, the device comprising a spacer system and a grid structure which grid structure is attached in spaced relation to the surface by means of the spacer system according to the invention in preferred embodiments is usable for the reduction of flow resistance or friction, for the prevention of biofouling, and/or as a sensor for flow or pressure.

For example, the bottom of ship hulls may be covered by a device comprising a spacer system and a grid structure to generate a stable air film on the hull to reduce friction. A continuous gas film can provide for a sustained drag reduction. Especially together with means for renewing the air layers, the flow resistance can be thus reduced. A preferred means for renewing the air layers is the microbubble technologies. The grid structures are also suitable for the cladding of tubes to reduce the flow resistance.

The device is adapted for stable gas retention on a surface under liquids. On the gas layer formed on the surface in a liquid thus forms a gas-liquid interface. The surfaces equipped with a grid structure also are usable in sensor technology, particularly as a sensor for flow and/or pressure, as described in DE 10 2015 104 257 A1. For example, forces deforming the grid structure can be determined by measuring the deformation of the spacers or by force measurement, or the deformation of the grid structure or the force affecting the interface between fluid and gas phase, or forces affecting can be determined using a surfaces equipped with a grid structure.

Unless otherwise defined, the technical and scientific terms used herein have the same meaning as commonly understood by one of ordinary skill in the art to which this invention belongs.

The Examples, which follow serve to illustrate the invention in more detail but do not constitute a limitation thereof.

The figures show:

FIG. 1: a schematical representation of a grid structure with square end slots.

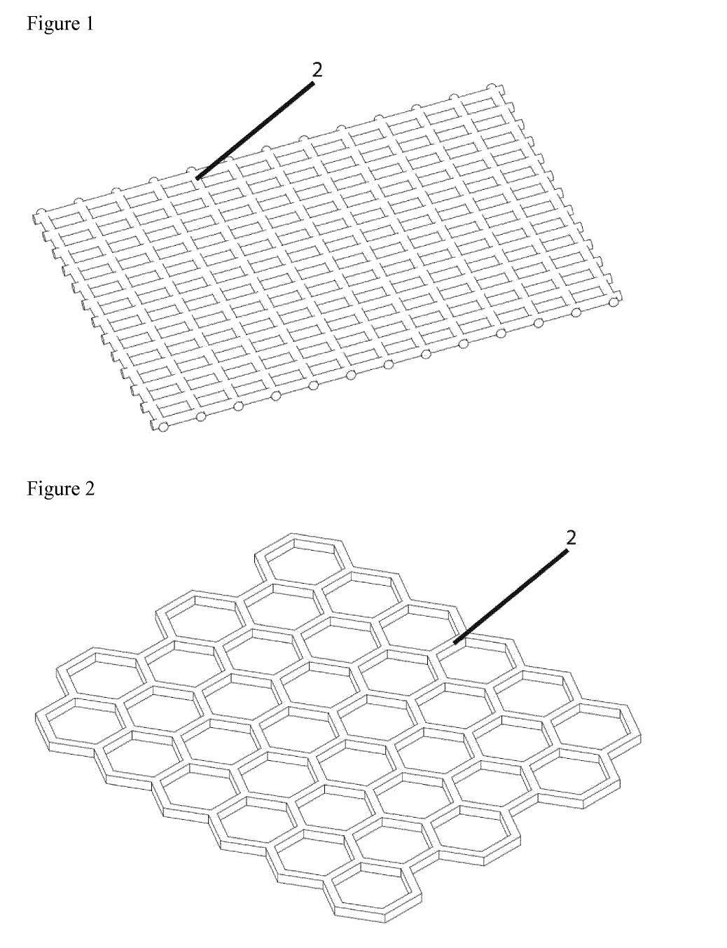

FIG. 2: a schematical representation of a honeycomb-like grid structure.

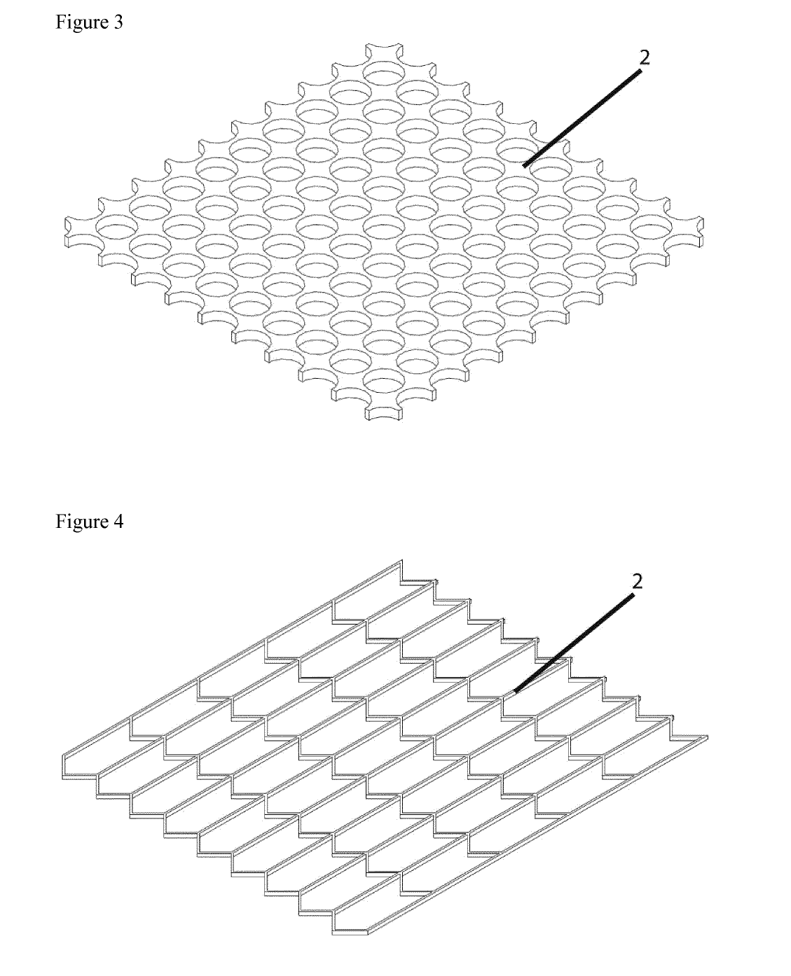

FIG. 3: a schematical representation of a grid structure with a schematical representation of round apertures.

FIG. 4: a schematical representation of a grid structure with arrow-shaped apertures.

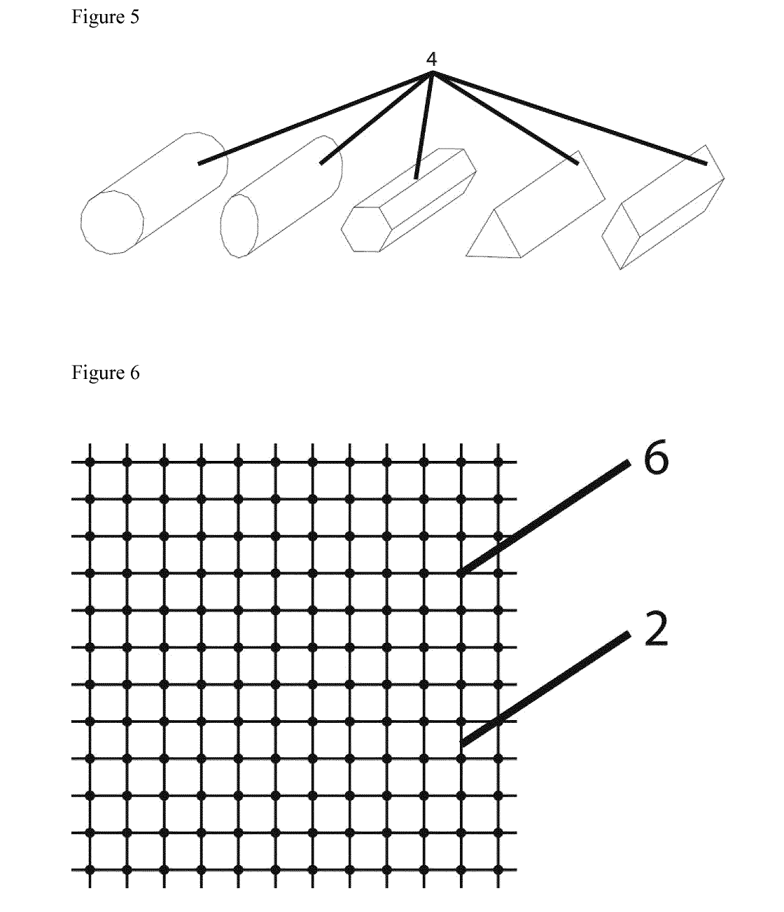

FIG. 5: a schematical representation of different cross sections of grid filaments.

FIG. 6: a schematical representation of a top view of a grid structure.

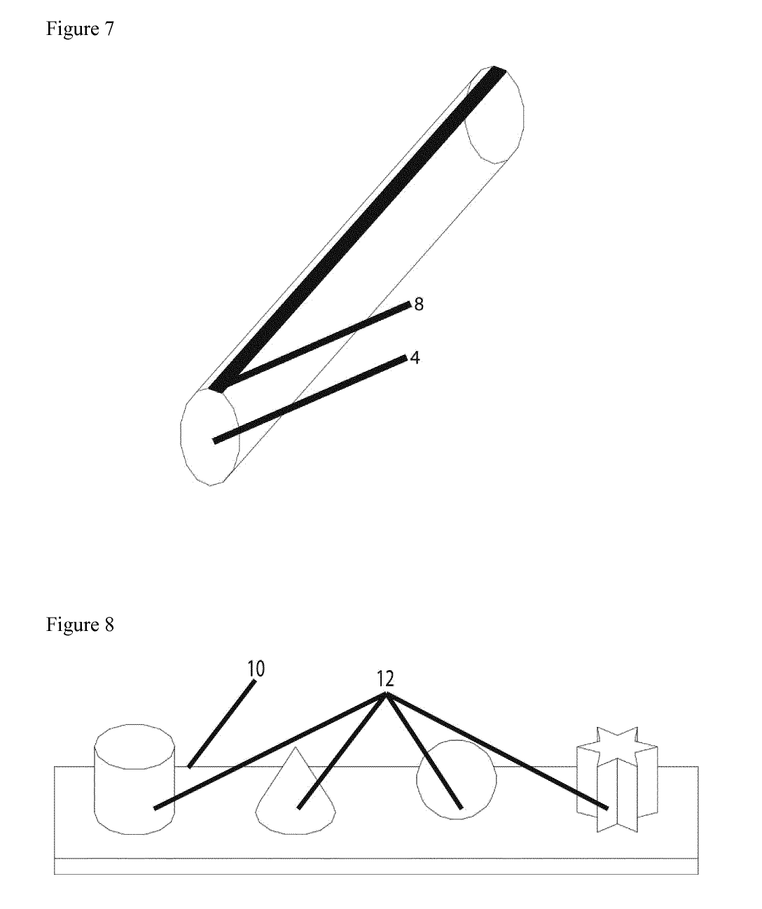

FIG. 7: a schematical representation of a grid filament.

FIG. 8: a schematical representation of different spacers on a surface.

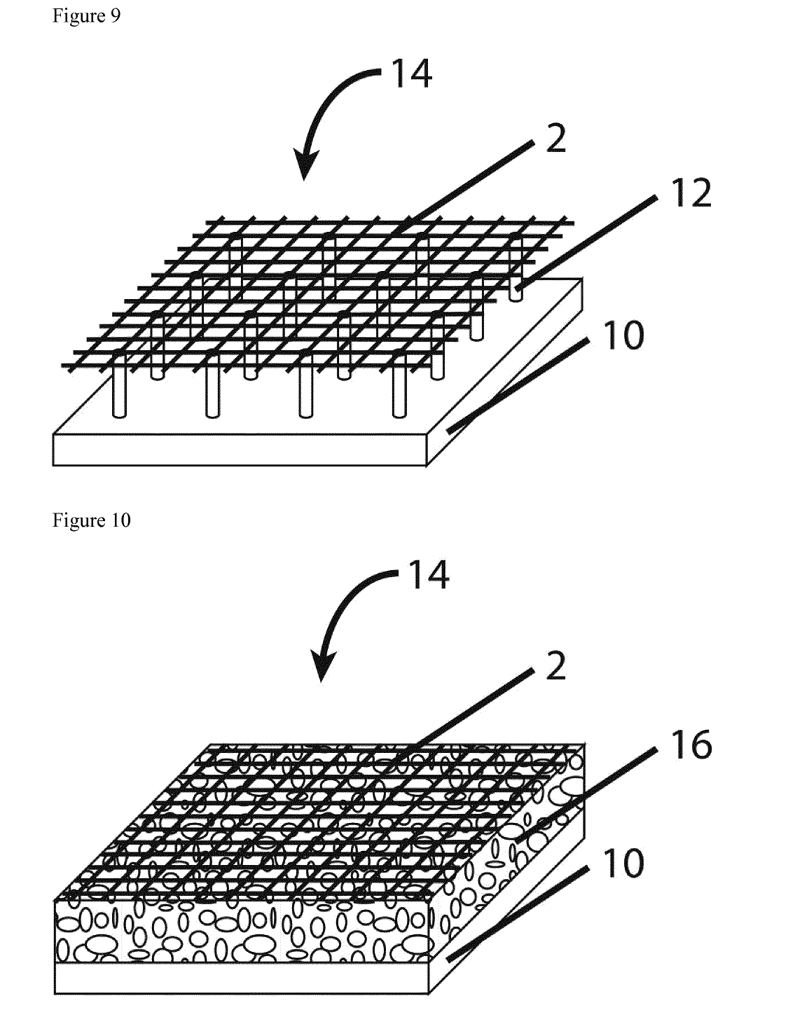

FIG. 9: a schematical representation of a device comprising a spacer system and a grid structure which is attached in spaced relation to a surface by the spacer system according to an embodiment of the invention.

FIG. 10: a schematical representation of a device comprising a spacer system and a grid structure which is attached in spaced relation to a surface by the spacer system according to another embodiment.

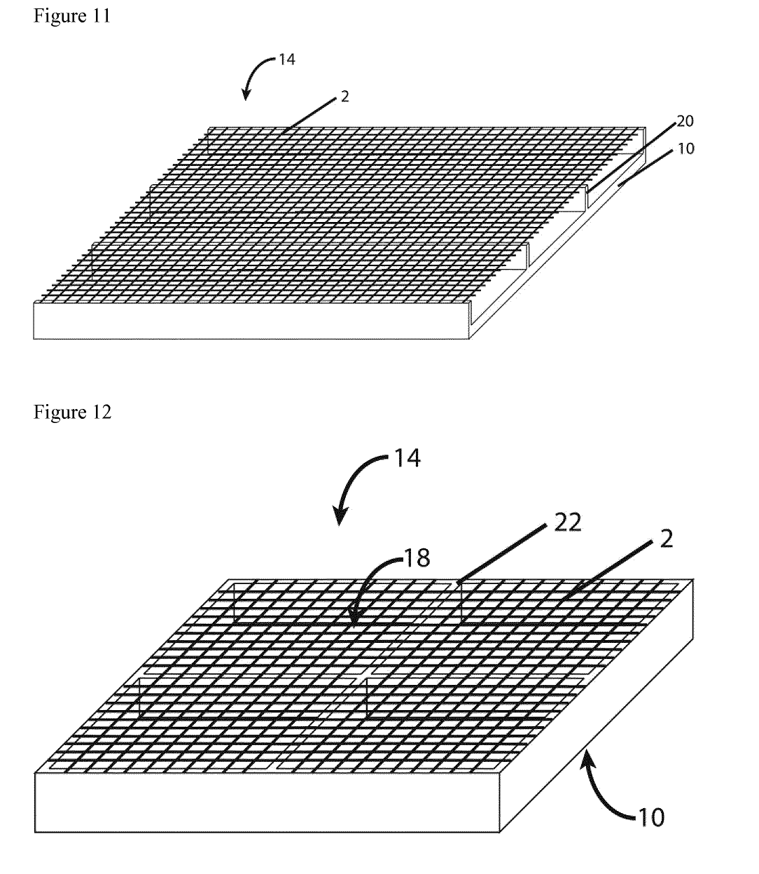

FIG. 11: a schematical representation of a device comprising a spacer system and a grid structure which is attached in spaced relation to the surface by wall-like spacers according to a further embodiment.

FIG. 12: a schematical representation of a device comprising a spacer system and a grid structure which is attached in spaced relation to the surface by wall-like spacers providing a compartmentation according to a further embodiment.

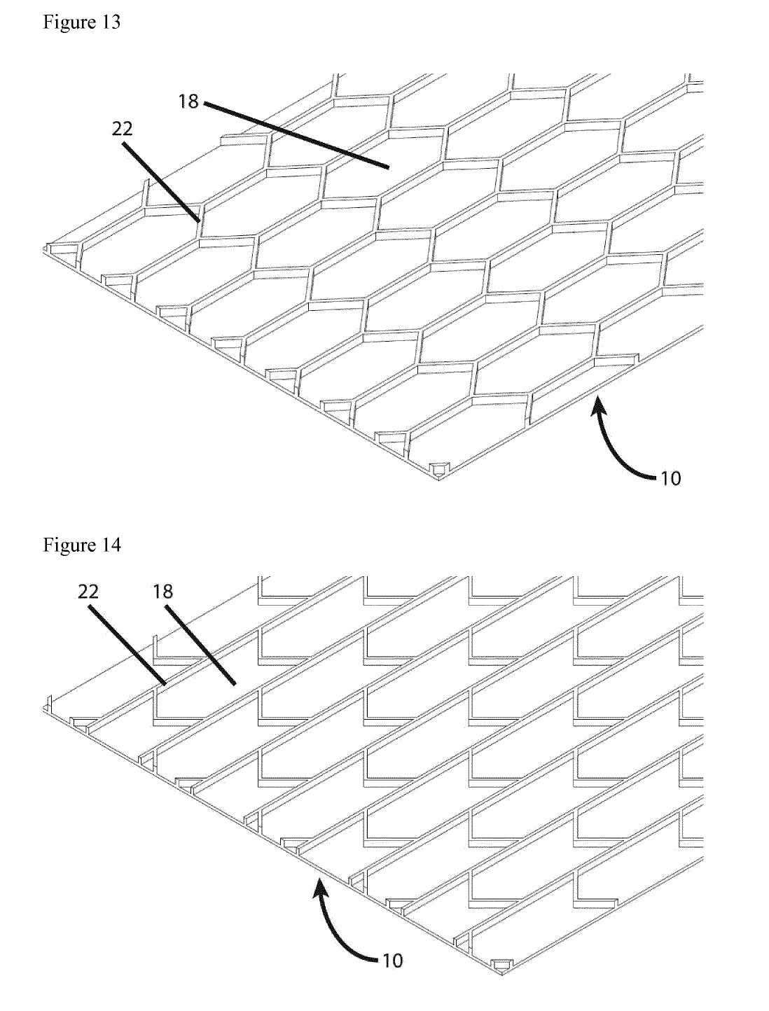

FIG. 13: a schematical representation of a surface comprising a grid structure with wall-like spacers providing hexagonal compartments on the surface.

FIG. 14: a schematical representation of a surface comprising a grid structure with wall-like spacers providing arrow-like compartments on the surface.

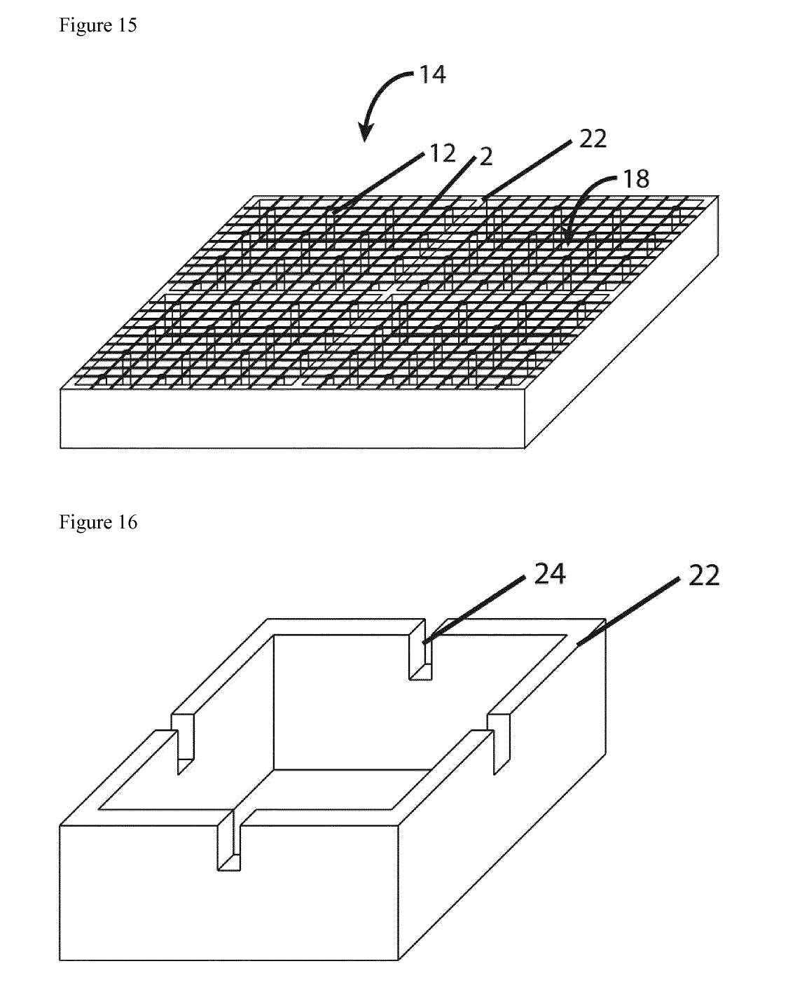

FIG. 15: a schematical representation of a compartimentized surface comprising a grid structure which is attached in spaced relation to the surface by spacer bars providing compartments according to a further embodiment.

FIG. 16: a schematical representation of a compartment having rectangular through openings in the wall-like spacers.

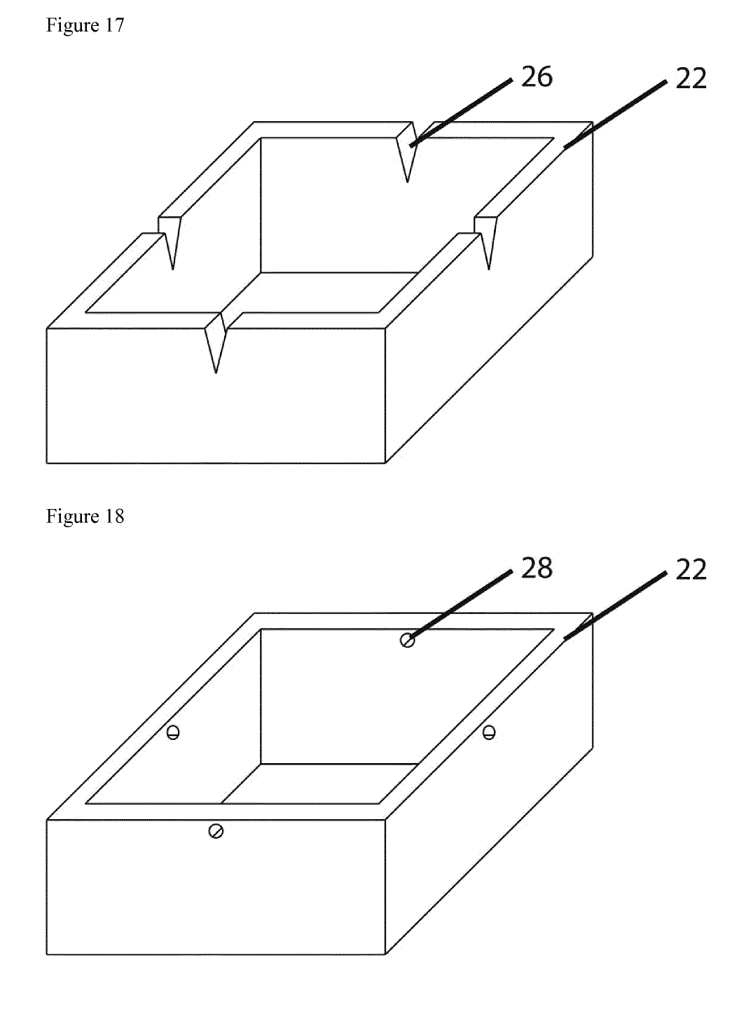

FIG. 17: a schematical representation of a compartment having triangular through openings in the wall-like spacers.

FIG. 18: a schematical representation of a compartment having circular holes in the wall-like spacers.

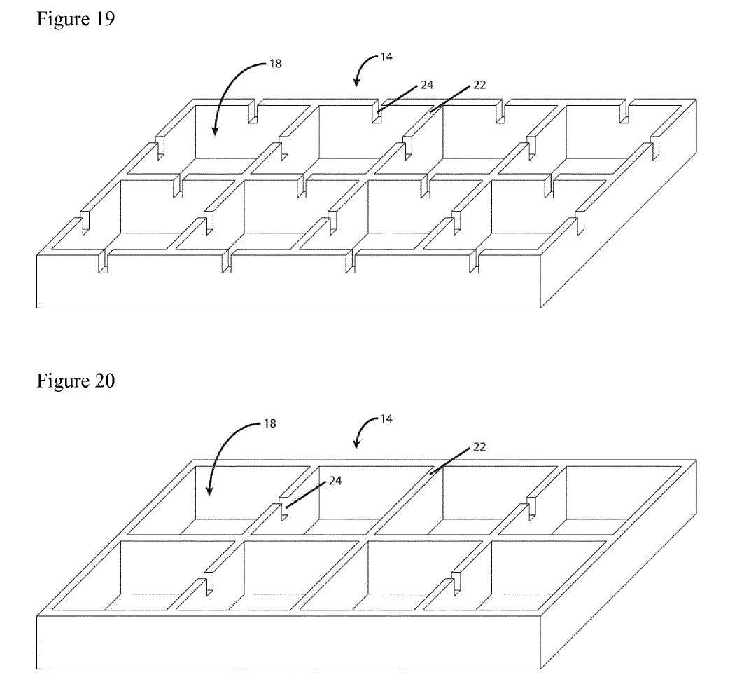

FIG. 19: a schematical representation of a surface with several compartments, each interconnected via through openings.

FIG. 20: a schematical representation of a surface with several compartments, each compartment being interconnected with one further compartment.

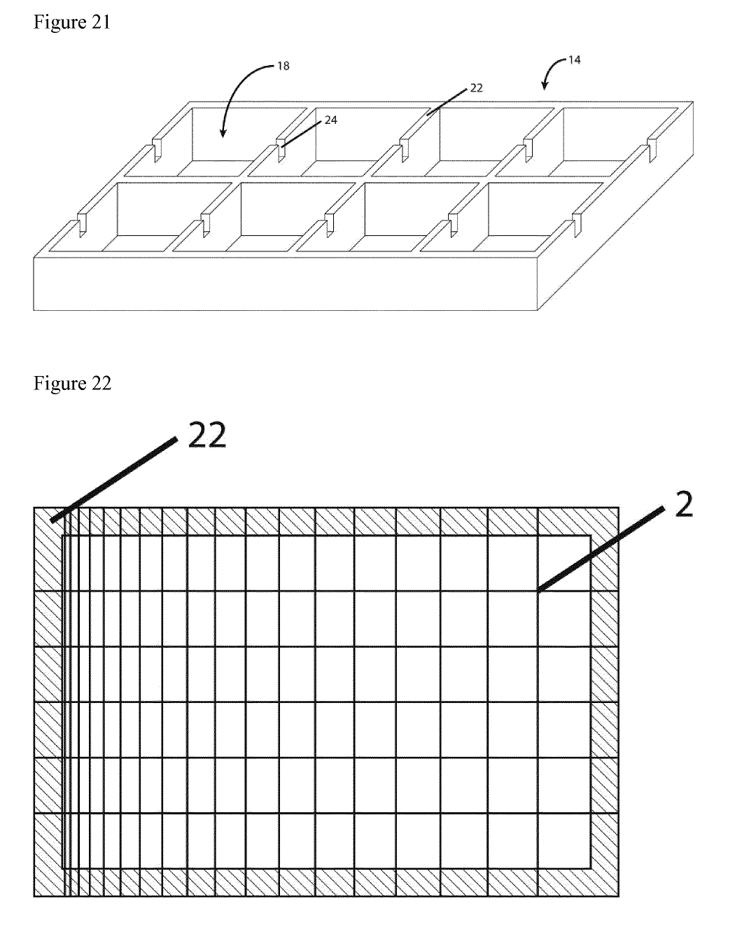

FIG. 21: a schematical representation of a surface with several compartments, wherein aligned compartments are interconnected.

FIG. 22: a schematical representation of a top view of a compartment of a surface with a grid structure having mesh openings of varying size.

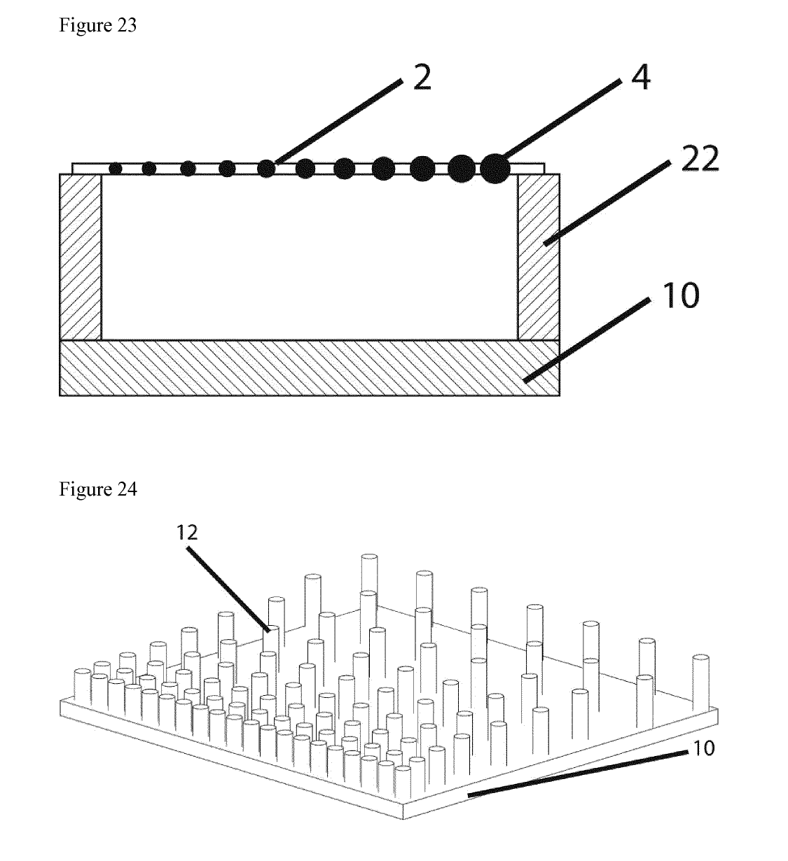

FIG. 23: a schematical representation of a cross section of a compartment according to a further embodiment.

FIG. 24: a schematical representation of a surface comprising spacers according to a further embodiment.

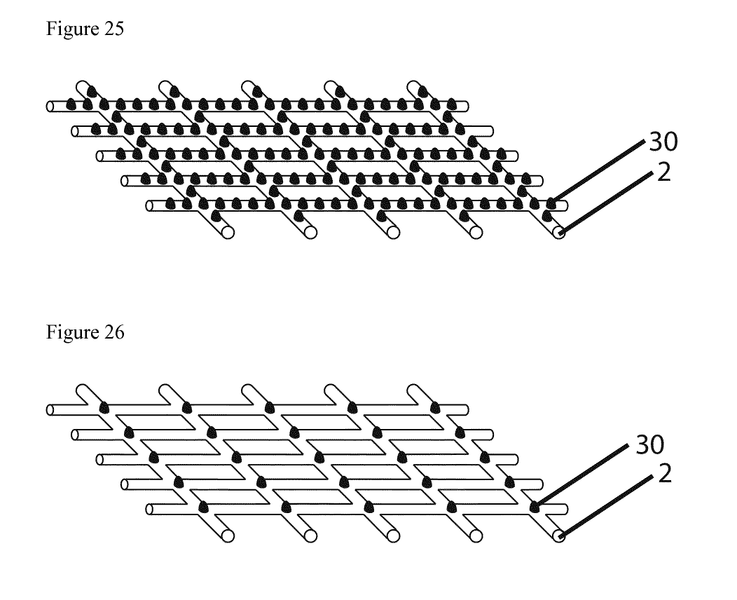

FIG. 25: a schematical representation of a grid structure comprising protrusions on the grid surface.

FIG. 26: a schematical representation of a grid structure comprising protrusions on junctions of the grid structure.

FIGS. 1 to 4 schematically show different grid structures 2, wherein FIG. 1 shows a grid structure 2 having square end slots, and FIG. 2 a honeycomb-like grid structure 2. FIG. 3 shows a grid structure 2 with round apertures. Such a grid structure can be provided by a perforated metal plate. The grid structure 2 shown in FIG. 4 has arrow-shaped apertures.

FIG. 5 shows a schematical representation of different cross sections of filaments 4 which can form a grid structure. The filaments 4 in the shown embodiments have round, oval, hexagonal, triangular or square cross sections.

FIG. 6 shows a schematical representation of a top view of a hydrophobic grid structure 2, wherein the nodes 6 of the grid provide a hydrophilic area. FIG. 7 shows a schematical representation of a grid filament 4 that comprises a hydrophilic area 8. The hydrophilic area 8 in this embodiment is provided on the top surface of the grid which will contact the fluid when a surface equipped with a grid formed from such grid filaments 4 comprising a hydrophilic area 8 is immersed in a fluid.

FIG. 8 shows a schematical representation of different spacers 12 on the surface 10 of an object. The spacers 12 have a rod-shaped, conical or ball-shaped form, or are rodlike with a starlike base.

FIG. 9 shows a schematical representation of an object 14 able to maintain a gas layer on the surface. According to the shown embodiment, on the surface 10 is mounted a device comprising a grid structure 2, which is attached to the surface 10 in spaced relation by spacers 12. A gas layer is held between the grid 2 and the surface 10. FIG. 10 shows a schematical representation of an object 14 able to maintain a gas layer on the surface. According to the shown embodiment, on the surface 10 is mounted a device comprising a grid structure 2 which is attached in spaced relation to the surface 10 by a spacer system formed by a porous layer 16. The gas, particularly air, is held between the grid 2 and the surface 10 in the porous layer 16.

FIG. 11 shows a schematical representation of another embodiment of an object 14 able to maintain a gas layer on the surface. On the surface 10 is mounted a device comprising a grid 2 which is kept in spaced relation to the surface 10 by wall-like spacers 20. In the schematical representation of the embodiment of an object 14 which is able to maintain a gas layer on the surface as shown in FIG. 12, the grid 2 is supported in spaced relation to the surface by wall-like spacers 22 which form compartments 18 on the surface. As a result the gas layer held between the grid 2 and the surface 10 also is divided into separate gas volumes.

FIGS. 13 and 14 schematically show embodiments of a surface 10 on which is mounted a device comprising a grid structure with wall-like spacers 22, which provide oblong, hexagonal compartments 18 as shown in FIG. 13 or arrow-like compartments 18 as shown in FIG. 14 on the surface 10.

FIG. 15 shows a schematical embodiment of an object 14 that is able to maintain a gas layer on the surface. The surface is compartimentized and comprises several compartments 18 each comprising a separate gas volume. The grid 2 is supported by the wall-like spacers 22 and the spacers 12.

FIGS. 16, 17 and 18 show schematical representations of a compartments comprising through openings in the wall-like spacers 22. The FIG. 16 shows rectangular through openings 24, the FIG. 17 triangular through openings 26, and the FIG. 18 shows round holes 28 in the wall-like spacers 22. The through openings 24, 26 and 28 allow for a conjunction of the gas layer, but the construction will separate the compartments upon pressure.

FIGS. 19, 20 and 21 show schematical representations of an object 14 that is able to maintain a gas layer with several compartments 18, which are interconnected. In the FIG. 19 each of the compartments are interconnected via through openings 24. In FIG. 20 each compartment is interconnected with one adjacent compartment. One of the wall-like spacers 22 of each compartment comprises an through openings 24. In FIG. 21 the compartments aligned in a row are interconnected via through openings 24 in the wall-like spacers 22.

FIG. 22 shows a schematical representation of a top view of a compartment of a surface that is able to maintain a gas layer. The grid structure 2 is supported by the wall-like spacers 22. The mesh openings are of varying size, wherein the mesh opening is smaller at the left of the compartment. Such variations in the mesh openings can compensate for variations in the in the mechanical stress such as drag acting on the compartment.

FIG. 23 shows a schematical representation of a cross section of a compartment. The grid structure 2 is supported by the wall-like spacers 22 on the surface 10. The filaments 4 forming the grid structure 2 show varying cross sections. Such varying cross sections of the filaments can compensate for variations in the in the mechanical stress such as drag acting on the grid structure 2.

FIG. 24 shows a schematical representation of a surface 10 comprising spacers 12 suitable to support a grid structure, which is not shown, according to a further embodiment. The distance between the spacers 12 varies. The spacers 12 also vary in the dimensions of the spacers. Such variations in the distance and dimensions of the spacers also allow for a compensation of variations in the in the mechanical stress such as drag acting on the grid structure.

FIG. 25 shows a schematical representation of a grid structure 2, wherein the grid structure 2 comprises protrusions 30 on the grid surface. The protrusions 30 are provided in regular distance from each other. Such protrusions allow for providing an enlarged gas or air layer on the surface extending to the tips of the protrusions.

FIG. 26 shows a schematical representation of a grid structure 2, wherein the grid structure 2 comprises hydrophilic protrusions 30 on junctions of the grid structure 2. The hydrophilic protrusions 30 are provided on the top surface of the grid, which will contact the fluid when a surface equipped with the grid is immersed in a fluid. Such hydrophilic protrusions 30 may provide for a pinning effect and stabilize the gas-liquid-interphase.

### EXAMPLE 1

A Teflon® grid having a mesh size of 0.1 mm and a steel net having a mesh size of 1 mm were fixed on plastic containers with a rectangular cross section having external dimensions of 25×25×4 mm³, and dimensions of a recess of 22×22×2 mm³. The grids and containers were hydrophobized with Tegotop® 210 (Evonik) and immersed in water. The containers were able to retain a gas film on the surface for several weeks under water.

### EXAMPLE 2

The effect of different dimension of openings in grid structured on the stability of gas films was determined. For this, round, hexagonal and rectangular opening of a minimal hole diameter of 300 μm to a major hole diameter of 8 mm were used.

Twelve different grid structures were used: metal perforated plates with round openings of different sizes (1.5-8 mm) (JAERA GmbH & Co. KG; Dillinger Fabrik gelochter Bleche GmbH) and metal perforated plates with hexagonal apertures of two sizes (2 mm and 6 mm), an epoxy replica (TOOLCRAFT Epoxyharz L; Conrad Electronic SE) of five of these perforated plates (Rv 1.5/2.5; Rv 2/3; Rv 3/4; SkL 2/2.5), two woven wire cloths (agar Scientific), a plastic web screen (Tesa® insect stop, tesa SE) and two Teflon® webs (ETFE Screen, 20 mesh and 50 mesh; TED PELLA, INC.). Table 1 summarizes the dimensions of the apertures of the perforated plates, Table 2 summarizes the dimensions of the mesh size of the webs and the woven wire web.

TABLE 1
dimensions of the apertures of the perforated
plates from metal and epoxy resin

| | | hole diameter | center distance |
|---|---|---|---|
| indication | perforation | [mm] | [mm] |
| Rv 1.5/2.5 | round, staggered | 1.5 | 2.5 |
| Rv 2/3 | round, staggered | 2 | 3 |
| Rv 3/4 | round, staggered | 3 | 4 |
| Rv 6/8 | round, staggered | 6 | 8 |
| Rv 8/12 | round, staggered | 8 | 12 |
| SkL 2/2.5 | hexagonal | 2 | 2.5 |
| SkL 6/6.7 | hexagonal | 6 | 6.7 |

TABLE 2
mesh size of the webs and woven wire cloth

| indication | mesh size [mm] |
|---|---|
| wire web, fine | ca. 0.35 |
| wire web, coarse | 0.6 |
| Teflon grid, fine | 0.3 |
| Teflon grid, coarse | 0.9 |
| plastic web screen | 1.2 |

Experiments were performed using each of the grid structures on two different types of samples with chambers of two different sizes: a square chamber having an edge length of 12 mm and a depth of 2 mm, and a smaller hexagonal chamber having a diameter of 7 mm and a depth of 4 mm. The grids were fixed on the respective samples (9 chambers below the grid in case of the square chambers, 7 chambers below the grid in case of the hexagonal chambers) with glue and hydrophobized with Tegotop® 210 (Evonik). Afterwards the samples equipped with the different grids were immersed into water to a depth of 20 mm and fixed by using putty (plastic-fermit Installationskitt, fermit GmbH).

After two weeks the samples were cautiously removed from the water. Using indicator paper the bottom of the chambers was examined in view of moisture to determine if a water ingress had occurred. For the samples with the bigger chambers of an edge length of 12 mm, nine pieces of indicator paper were used (one in each chamber), the smaller chambers were sampled using seven papers (one in each chamber).

Regarding the grids fixed on the 12 mm-chambers, using the fine Teflon grid with a mesh size of 0.3 mm it was seen that six out of nine test sites remained dry, representing the best result achieved. Also the fine wire web with a mesh size of 0.35 mm showed a stable gas film on the bottom surface. Regarding the grids fixed on the 7 mm-chambers, the fine Teflon grid with a mesh size of 0.3 mm showed that all seven test sides remained dry, while for the coarse Teflon grid with a mesh size of 0.9 mm only one test side was moist. Also for the perforated plate Rv 1.5/2.5 all seven test sides remained dry. This shows that a stable gas film was kept using all structures and mesh sizes.

The test run was repeated using similar conditions. In the second run, regarding the grids fixed on the 12 mm-chambers, the fine Teflon grid and the fine wire web again showed best results. Also the plastic web screen (1.2 mm), the coarse Teflon grid and the perforated metal plate Rv 2/3 showed good results. The bottom of the chambers under the fine and the coarse wire webs remained dry over the test period.

Regarding the grids fixed on the 7 mm-chambers, only the perforated metal plates Rv 3/4 and Rv 2/2.5 showed occasional moist test sites. It is assumed that these were caused by a flawed coating of the grids.

The results of the first and second test run show that the grid structures except the biggest grids Rv 6/8 and Rv 8/12 provided a stable gas film for the test period of two weeks. The fine Teflon grid with a mesh size of 0.3 mm showed the best test results. Generally it was seen that the smaller and deeper chamber (7 mm) provided better results compared with the 12 mm-chamber. However, all the tested grids except the biggest grids Rv 6/8 and Rv 8/12 and chambers were able to stable keep a gas layer on the surface when immersed into water over two weeks.

1. A device mountable on a surface (10), the device comprising a spacer system (12, 16, 20, 22) and a grid structure (2) which grid structure (2) is attached in spaced relation to the surface (10) by means of the spacer system (12, 16, 20, 22), wherein the distance between the surface (10) and the grid structure (2) is in a range from ≥0.1 μm to ≤10 mm, wherein the grid structure (2) forms meshes of a mesh size in a range from ≥0.5 μm to ≤8 mm, and wherein the surface of the grid structure (2) is at least partially amphiphobic.

2. The device according to claim 1, wherein the grid structure is provided by a perforated plate, a grating, a net, a woven or non-woven mesh, or is formed by woven or non-woven filaments.

3. The device according to claim 1, wherein the distance between the surface (10) and the grid structure (2) is in a range from ≥1 μm to ≤6 mm.

4. The device according to claim 1, wherein the grid structure (2) forms meshes of a mesh size in a range from ≥5 μm to ≤2 mm.

5. The device according to claim 1, wherein the spacer system (12, 16, 20, 22) is formed by solitary rodlike bars (12) or wall-like ledges (20, 22), or by a porous layer (16), or the spacer system is a combination thereof.

6. The device according to claim 1, wherein wall-like ledges (20, 22) form compartments (18) on the surface (10).

7. The device according to claim 1, wherein the wall-like ledges (20, 22) comprise through openings (24, 26, 28) to provide an exchange of gas between adjacent compartments (18).

8. The device according to claim 1, wherein the grid structure (2) comprises protrusions (30) on the grid surface.

9. An object comprising a device mountable on a surface (10), the device comprising a spacer system (12, 16, 20, 22) and a grid structure (2) which grid structure (2) is attached in spaced relation to the surface (10) by means of the spacer system (12, 16, 20, 22) according to claim 1.

10. A method of maintaining a gas or air layer on a surface (10) when the surface is immersed in a liquid or water, the method comprising providing a device mountable on a surface (10), the device comprising a spacer system (12, 16, 20, 22) and a grid structure (2) which grid structure (2) is attached in spaced relation to the surface (10) by means of the spacer system (12, 16, 20, 22), wherein the distance between the surface (10) and the grid structure (2) is in a range from ≥0.1 μm to ≤10 mm, wherein the grid structure (2) forms meshes of a mesh size in a range from ≥0.5 μm to ≤8 mm, and wherein the surface of the grid structure (2) is at least partially amphiphobic.

11. Use of a device mountable on a surface (10), the device comprising a spacer system (12, 16, 20, 22) and a grid structure (2) which grid structure (2) is attached in spaced relation to the surface (10) by means of the spacer system (12, 16, 20, 22) according to claim 1 for the reduction of flow resistance or friction, for the prevention of biofouling, and/or as a sensor for flow or pressure.

12. The device according to claim 1, wherein the distance between the surface (10) and the grid structure (2) is in a range from ≥10 μm to ≤2 mm.

13. The device according to claim 1, wherein the grid structure (2) forms meshes of a mesh size in a range from ≥10 μm to ≤800 μm.
